(19) United States
(12) Patent Application Publication
(10) Pub. No.: US 2004/0238524 A1
(43) Pub. Date: Dec. 2, 2004

(54) Method using light emitting diodes of warning individuals about hot surfaces on stoves

(76) Inventor: William S. Lerner, New York, NY (US)

Correspondence Address: Steven Horowitz, Counselor At Law, Suite 700, 295 Madison Avenue, New York, NY, 10017, US

(21) Appl. No.: 10/687,513

(22) Filed: Oct. 16, 2003

Related U.S. Application Data
(63) Continuation-in-part of application No. 10/446,916, filed on May 27, 2003.

(51) Int. Cl. H05B 3/68

(52) U.S. Cl. 219/445.1; 219/506

(57) ABSTRACT

Method of warning individuals about hot surfaces on stoves and related appliances containing multiple heating elements by installing a configuration of light emitting diodes (or organic LEDs) that comprises a heat warning symbol specific to that one heating element, the LEDs receiving electric power whenever a specified temperature of that heating element is exceeded in accordance with a controller that receives information from the heat sensor adjacent the heating element. The symbols are positioned so that an observer approaching a heating element of stove from any direction when the heating element is dangerously hot can understand the symbol for that heating element. The arrangement of LED's may form a perimeter around the heating element interrupted by the letters “HOT” or partially encircle the heating element in different embodiments and is positioned between the heating element and an observer. The symbols are adjustable for brightness and can incorporate sound and blinking.

### PRIORITY INFORMATION

The present patent application is a continuation-in-part patent application of and claims priority from (a) pending U.S. patent application Ser. No. 10/446,919 (“Heat Warning Safety Device Using Light Emitting Diodes”) filed May 28, 2003 by Applicant herein William S. Lerner, which application is herein incorporated by reference in its entirety, (b) pending U.S. patent application Ser. No. 10/429,111 (“Heat Warning Devices Directly Applicable to Hot Surfaces”) filed May 2, 2003 by Applicant William S. Lerner which is incorporated herein by reference in its entirety, (c) pending U.S. patent application Ser. No. 09/788,594 (“Heat Alert Safety Device for Smoothtop Stoves and Other Hot Surfaces”) filed by Applicant William S. Lerner on Feb. 21, 2001 which is incorporated herein by reference in its entirety, (d) pending U.S. patent application Ser. No. 10/238,348 (“Enhanced Visbility Heat Alert Safety Device for Hot Surfaces”) filed Sep. 10, 2002 by Applicant William S. Lerner which is incorporated herein by reference in its entirety, and (e) Applicant William S. Lerner's issued U.S. Pat. No. 6,104,007 entitled “Heat Alert Safety Device For Stoves and Related Appliances” which is incorporated herein by reference in its entirety.

### FIELD OF THE INVENTION

The field of this invention is methods of warning individuals about hot surfaces, and more particularly, such methods that employ warning devices for warning individuals that a surface of a smoothtop and electric stove is dangerously hot.

### BACKGROUND OF THE INVENTION AND DISCUSSION OF THE PRIOR ART

With respect to stoves and related appliances, various kinds of stoves—electric, gas, smooth cooktop stoves which use glass or metal tops—and toaster ovens are well known to be used for heating food. In addition, “mobile stove-type appliances” such as hot plates and warming trays are well known to be used for heating food. Each of these kinds of stoves and “mobile stove-type appliances” present a safety problem since the heating elements of the stove are hot during the cooking process and remain hot well afterwards. During the cooking process, the safety problem caused by touching the heating element is mitigated somewhat by visual inspection of the stove. With a gas, electric or smooth top stove, for example, the presence of a pot or other utensil on top of the stove might alert someone to the fact that the stove appears to be in use for cooking and therefore too hot to touch. Even the presence of a pot or other utensil is not a reliable clue, however, since people tend to leave tea kettles on their stove perpetually. When the cooking process has ended, however, it is generally impossible to detect that the heating elements of the stove remains hot and would burn the skin of anyone who touched them. There is no visual or other clue that the stove is hot.

To some degree, adults have developed an inherent caution when approaching stoves because of their experience and knowledge in dealing with such safety problems. This inherent caution, however, does not obviate the need for a device that warns the adult when touching the stove would be dangerous. Moreover, children, and particularly young children, usually have not developed such a watchfulness and there has long been a need for a device that can prevent burn accidents to children who may inadvertently touch a stove that is hot, especially when the stove remains hot well after the cooking process has ended.

Furthermore, the reduction in the size of modern kitchens has led the occupants of modern apartments to make use of the stove as an extension of the counter top adjacent the stove as a resting places for large items that have been carried into the kitchen area. An example of such items is heavy bags of groceries brought into the kitchen. There is an urge to set the bags down on the nearest flat surfaces, which may be the top of a stove adjacent a counter top. This is particularly true for those stoves that are smooth on top, such as smooth cooktops. In general, the top surfaces of modem kitchen stoves are increasingly flat, especially the top surfaces of smooth cooktops. These factors have only increased the danger to adults when the top surfaces of stoves are used as a resting place for packages, such as groceries brought into the kitchen.

Smooth cooktop stoves presently are also dangerous if touched on their top surface when they are still hot, even after use. These smooth cooktop stoves, or “smoothtops” as they are sometimes called, utilize as the heating element separate areas on the top surface of the stove (at the same location that gas stove would have burners) which are made of glass. Under each area, usually circular, is a strong light source, such as a halogen lights. The light source projects the light upward to the surface area of the smoothtop's heating element—the glass area on the top surface of the stove. Since the glass area is coated on its bottom with a dark coating, when the light strikes it, the heat from the strong light is absorbed by the glass area and these glass surfaces form each heating element of the stove.

Another variation of the smooth cooktop is the use of a “ribbon heating element” where the smooth glass surface is heated by a coiled electric circuit called a “ribbon element” just underneath it instead of by a halogen light source. The heat is transmitted directly upward so that only the heat element itself gets hot and the rest of the cooktop surface remains cool. In some cases, the ribbon heating element also has another feature whereby the heating element is made of two concentric circles so that the option exists of two sizes of the heating element to match the two different sizes of the pans that need to be heated. This new technology does not solve the problem of warning adults and children that the heating element should not be touched when the cooking process has ended. If anything, it generates the additional hazard that someone can be lulled into touching the heating element after thinking the heating element is cool since the surface right adjacent to it is indeed cool.

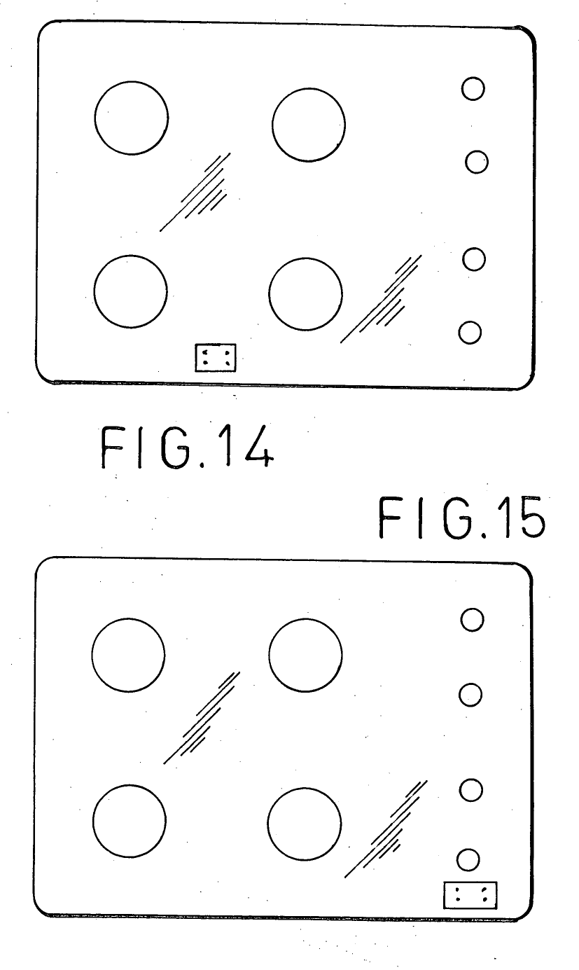

Presently, in order to address the danger of touching a hot “smoothtop” stove, such stoves generally have several light indicators, each one corresponding to each heating element, all located in small one rectangular area on the surface of the cooktop. See FIGS. 14 and 15 herein. The light indicators remain lit for a certain length of time after the stove's heating element is turned off in order to deter someone from touching the heating element when it is still hot, although “off”. The light indicators themselves consist of a “dot” or red LED or other indicator, each dot corresponding to a different heating element. Unfortunately, this attempt to address the danger of touching a hot stove of the smooth cooktop variety is insufficient as a warning system (putting aside the fact that the light indicators are designed only for the smooth cooktop variety stoves to begin with and not for gas and electric coil stoves).

A quick glance at the group of light indicators would not be sufficient to warn the average adult, no less children or the elderly, that a particular heating element is too hot. This is because the group of light indicators do not immediately tell someone which heating elements correspond to which light indicators. At a minimum, several seconds of concentration are needed in order to determine from the light indicators that are “on”, which heating elements are too hot to touch. Many adults, and certainly most children, cannot afford those seconds of deduction since their desire to touch the stove is immediate. In fact, it only takes one second of contact for an adult at 167 degrees Fahrenheit to cause a burn and 160 degrees Fahreneheit for a child. It takes considerably less than second to terrify a child from the pain of a hot surface that is 115 degrees Fahrenheit. In addition, an adult carrying groceries into the kitchen and looking for a counter top to place them on or a child running into and playing in the kitchen are even less likely than the average adult or child to take the time to engage in a several second thinking process. Accordingly, the child or the adult will be inadequately warned about the danger of being burned. With this in mind, it is no surprise that a 1997 industrial design exhibit at the Cooper Hewitt (Smithsonian) in New York demonstrated that over 69% of adults can not match the control knob with its corresponding burner (i.e. heating element) on a stove.

Furthermore, the prior art heat indicators can be up to three feet away from the heating element to which they correspond. That distance is too far away for a dangerously hot surface. Surely one would not position a warning for an open air shaft three feet away.

Moreover, the use of a single red LED dot to communicate a warning of heat, while it may have been somewhat noticeable and somewhat effective as a heat warning symbol in the kitchen of the past, is completely ineffective today. In today's kitchen environment, the meaning of a dot of a red LED is dramatically diluted by the presence of a multitude of dots of red LED's all over the place in the modern sophisticated kitchen. For example, many appliances in the kitchen such as coffee pots, cell phones, corded phones, answering machines, computers, televisions, rechargeable flashlights, personal digital assistant devices, dustbusters, alarm keypads, motion sensors all have red lights or red LED's. This dilutes the meaning of a single red LED as an indicator of dangerous heat on a nearby heating element.

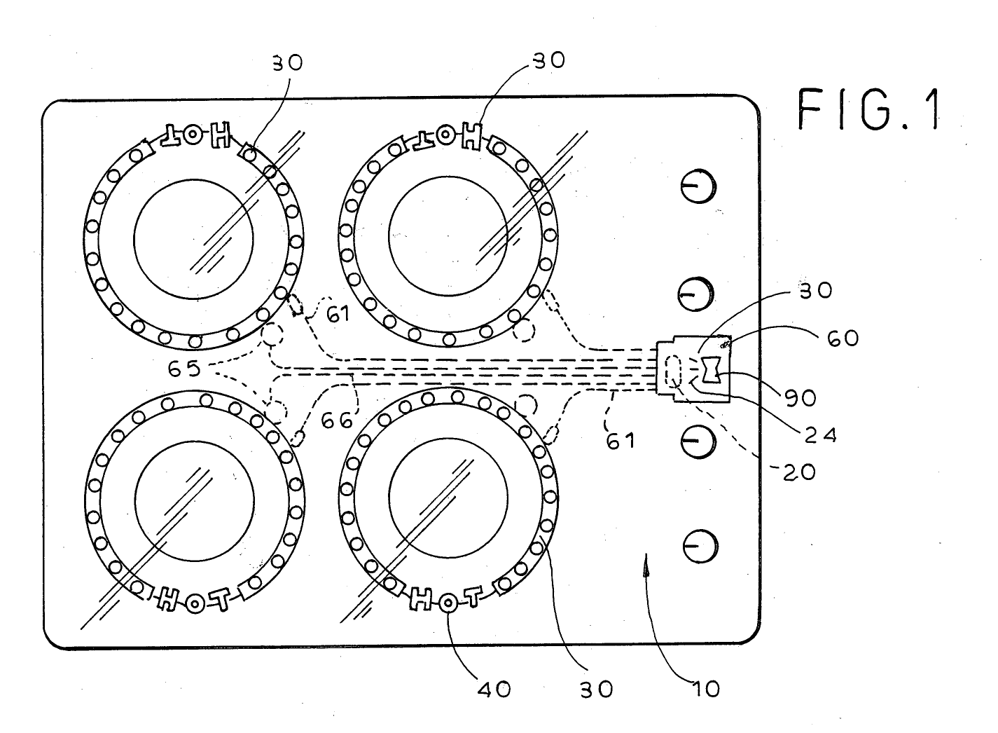

Moreover, for yet an additional reason, the above problems with existing heat indicators are even more pronounced when considered in the context of today's modern kitchen. The traditional kitchen in the past has been the domain of a stay at home mother. The kitchen contained one corded telephone and a cooktop stove would be plainly obvious and salient in such a kitchen. Today's kitchen is much more distracting. In today's kitchen, it is more common, at least in many households, for everyone to cook. Furthermore, the kitchen itself in many cases functions also as an entertainment room, a living room or a family room. The kitchen and its inhabitants feature cordless telephones, computers announcing “you have mail”, cell phones, pagers and people milling about “multi-tasking”, talking, drinking, socializing and not just cooking. Guests may be unfamiliar with cooking areas. Smoothtop stoves are not so distinctive in this environment since they have been re-designed to blend into the kitchen design. Smoothtops are also not immediately recognizable as smoothtops because the new designs are odd in shape. Also, where previously versions had a vent hood that stuck out, such vent hoods are now often built into the cabinet and remain unseen. Furthermore, stoves appear in islands in the middle of the kitchen separate from any oven rather than against the wall and adjacent the oven. Hence, a potentially hot surface can be approached from four different directions in a distracting environment when the danger may be hard to recognize. It is not hard to see that the prior art indicators, such as shown in FIG. 1, which appear on only one side of a cooktop stove, are practically useless in today's kitchen, even putting aside the fact that they require precious seconds of deduction to figure out which dangerously hot heating element it is supposed to correspond to the lit indicator warning light.

In addition, some people may not have grown up with smoothtops and may not recognize it. The elderly, children, visually impaired individuals would all have trouble using prior art heat warning indicators on a smoothtop to warn against the residual heat of a heating element on a smoothtop stove, or for that matter other stoves or hot surfaces.

Some of these problems have been addressed in Applicant's U.S. Pat. No. 6,104,007 and in pending patent applications, through use of heat warning safety devices that includes a warning symbol that appears directly on the heating element of a stove and by using thermochromic compositions such as for inserts or overlays. Thermochromic materials include liquid crystal (whether cholesteric or chiral nematic) compositions that change color when passing through a given temperature range, and such compositions are now familiar to consumers from their frequent use in inexpensive items, like temperature indicating refrigerator magnets or stick-on aquarium thermometers.

Heat alert safety devices based on thermochromic compositions situated in the center of each heating element and containing a predetermined symbol which changes color at a specified temperature has been discussed in Applicant's previous patents and patent applications, including U.S. patent application Ser. No. 09/788,594 filed Feb. 21, 2001 and U.S. patent application Ser. No. 10/429111 filed May 2, 2003 and the aforementioned U.S. Pat. No. 6,104,007 to Lerner These devices offer many important advantages. One potential drawback, however, is that devices based on thermochromic compositions are limited to heat environments in which the thermochromic composition is reliable at color changing and is stable. Furthermore, a thermochromic composition does not instantly change color but changes color somewhat gradually. Thermochromic compositions are harder to see in the dark or poorly lit room.

It is further desirable to have a heat warning symbol that can be adjusted in brightness so that it can be tailored to different individuals who have different levels of (i) visual capacity and (ii) awareness of the heat dangers. Children, visually impaired individuals, adults having one lifestyle or habits versus an adult having a different lifestyle or habit may require different degrees of brightness to warn themselves and individuals in their company of the hanger of a hot surface in their kitchen. Presently, such heat warning devices do not offer this ability. Even thermochromic compositions cannot readily be adjusted in brightness by the user without a complicated set up.

Consequently, there is a compelling need for a heat warning method or device that offers a heat warning symbol in an effective manner and in a manner that overcomes the disadvantages of the prior art. The present invention offers the above compelling advantages and many more advantages.

Preliminarily, moreover, it is noted that the present invention is applicable not just to stoves and related appliances, but to any other surface that one may need to be warned that it is hot, as long as it has access to a light source that can be activated under predetermined conditions. For example, there are numerous devices whose surfaces become hot and remain hot even after the device has been shut off either electrically or otherwise. For example, a radiator cap becomes hot and remains hot for a period when the vehicle and radiator are shut off. Also, any kind of piping that is a conduit for hot liquids is an example of a surface that one may need to be warned that it is hot. Other devices having hot surfaces include hot surfaces on fireplace doors, flat irons, chafing dishes, coffee urns, heating pipes, home radiators, glue guns, oven doors, portable heaters of the electric, oil and ceramic disc type, kerosene lamps, kerosene heaters, barbecue grills of the electric, gas or charcoal type, electric woks, electric skillets, deep fryers for home or commercial use, heat lamps in self service cafeterias and salad bars, saunas including the metal box that generates and/or controls the heat, rotisseries, indoor grills whether gas or electric, tea kettles, wood burning stoves, hot electric rollers, hot wax holders used for beauty treatments, bonnet type hair dryers, synthetic braid trimmers, curling irons, portable generators, steam cleaners especially such as in dry cleaning facilities, hot water pipes that are exposed, hot water heaters, furnaces, warming trays, light fixtures such as halogen lamps, popcorn makers (especially commercial ones), toasters, residential and commercial cappucino and espresso makers, autoclaves used to sterilize instruments in a medical setting, movie projectors, industrial steam machines and pressers, the metal surfaces in the cooking areas on an airplane, heat producing generators and other such hot surfaces. These and other hot surfaces are exposed to children, maintenance works and ordinary adult users.

### SUMMARY OF THE PRESENT INVENTION

Method of warning individuals about potentially hot surfaces on a stove containing two or more heating elements and having a source of electric power embedded within the appliance includes installing a controller on a top surface of the stove, installing, for each heating element on the surface, a heat sensor beneath the surface and adjacent the heating element, and installing for each heating element on the surface a plurality of light emitting diodes adjacent the heating element, the plurality of light emitting diodes in electric communication with the source of electric power (so that the plurality of light emitting diodes can be illuminated) and configured to represent a predetermined heat warning symbol. The symbol can by itself communicate to an observer who can also readily see the surface that the surface is dangerously hot and the symbol is readily visible only when illuminated. The controller is capable of receiving temperature information from the heat sensors and controlling the light emitting diodes so that whenever a specified surface temperature of a particular heating element is reached, the symbol is illuminated and remains illuminated as long as the specified surface temperature of that heating element is maintained. The heat warning symbols are positioned so that an observer approaching a heating element of the stove, and preferably approaching a heating element of the stove from any direction, when that heating element is dangerously hot can readily see and understand the heat warning symbol associated with that heating element.

The configuration of light emitting diodes that comprises a heat warning symbol specific to a particular heating element and receives electric power and is illuminated whenever and so long as a specified temperature of that heating element is exceeded. The controller of the LEDs receives information from a heat sensor adjacent the heating element.

In one embodiment, the heat warning symbol comprises an arrangement of LED's that forms a perimeter around the heating element interrupted by the letters “HOT” or partially encircles the heating element but is positioned between the heating element and an observer approaching the heating element

It should be noted that the warning device employed by the method of the present invention can be seen in the dark. This is significant since sometimes people cook or entertain in their kitchen in the dark. For example, when warming a bottle for an infant in the middle of the night, the parent may rely only on the nightlight of 4 Watts and use electric appliances in the dark kitchen.

### IMPORTANT OBJECTS AND ADVANTAGES

The following important objects and advantages of the present invention are:

(1) to provide a method of warning individuals employing a heat warning device that is able to be instantly illuminated whenever a specified temperature is reached;

(2) to provide a method of warning individuals employing a heat warning device that can be illuminated in a blinking mode as a form of warning;

(3) to provide a method of warning individuals employing a heat warning device whose warning symbol can be adjusted in brightness depending upon the type of people most likely to be exposed to the dangerously hot surface;

(4) to provide a method of warning individuals employing a heat warning device that is reliable and stable regardless of the temperature levels in its environment up to at least 1200 degrees Fahrenheit;

(5) to provide a method of warning individuals employing a heat warning device that can be used to warn that a surface may be dangerously hot by including the letters “HOT” in the warning symbol;

(6) to provide a method of warning individuals employing a heat warning device that combines visual and auditory cues to maximize warning impact;

(7) to provide a method of warning individuals employing a heat warning device that allows a person to instantly recognize which hot surface is dangerously hot and needs to be avoided;

(8) to provide a method of warning individuals employing a heat warning device that alerts people that a surface is dangerously hot even when the heat source that caused the surface to be hot has been turned off;

(9) to provide a method of warning individuals employing a heat warning device that is easy to manufacture and can be readily integrated into the manufacturing of known stoves and appliances;

(10) to provide a method of warning individuals employing a heat warning device that includes a heat warning symbol that appears immediately adjacent, or in some embodiments, in the center of, the heating element of a gas stove, an electric stove or a smooth cooktop or other stove or appliance including but not limited to grills and steamers;

(11) to provide a method of warning individuals employing a heat warning safety device that is effective for children, adults, the elderly and visually impaired individuals; and

(12) to provide a method of warning individuals employing a heat warning safety device that can be readily seen and be effective in the dark. BRIEF DESCRIPTION OF THE DRAWINGS

FIG. 1 is a top plan view of the heat warning safety device of the present invention used on a smooth cooktop stove showing a particular configuration of LEDs;

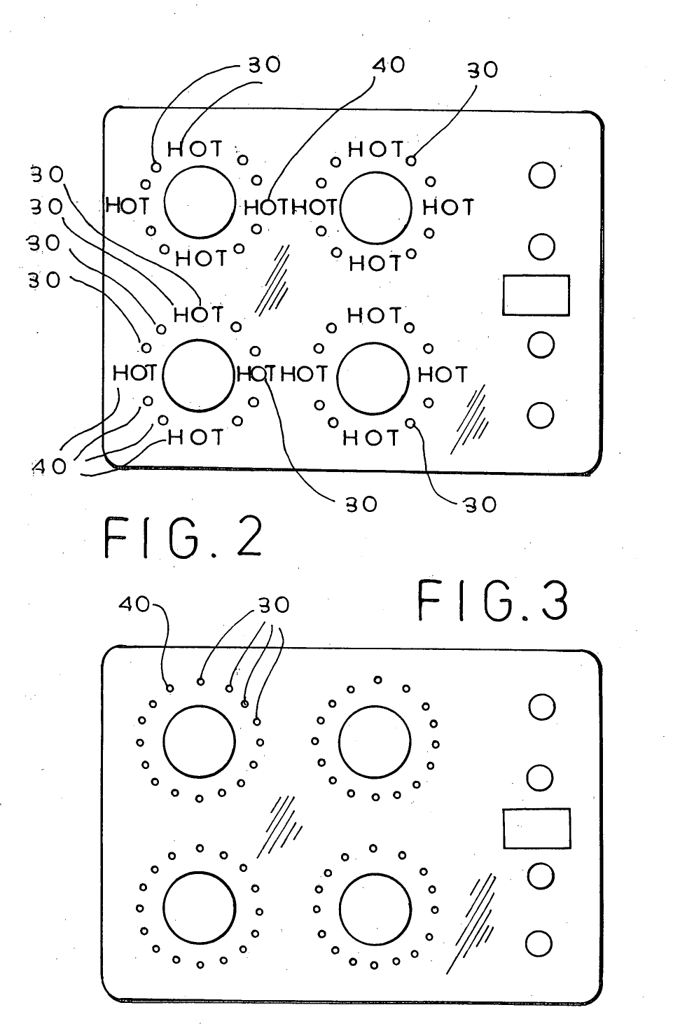

FIG. 2 is a fragmentary plan view of an alternative embodiment of the heat warning safety device of the present invention;

FIG. 3 is a fragmentary plan view of an alternative embodiment of the heat warning safety device of the present invention;

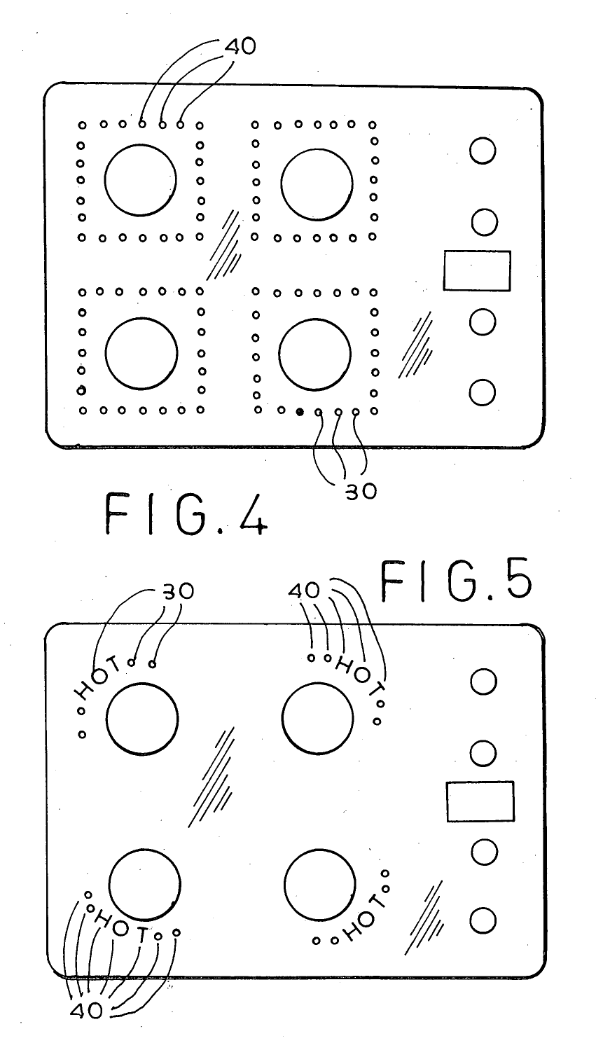

FIG. 4 is a fragmentary plan view of an alternative embodiment of the heat warning safety device of the present invention;

FIG. 5 is a fragmentary plan view of an alternative embodiment of the heat warning safety device of the present invention;

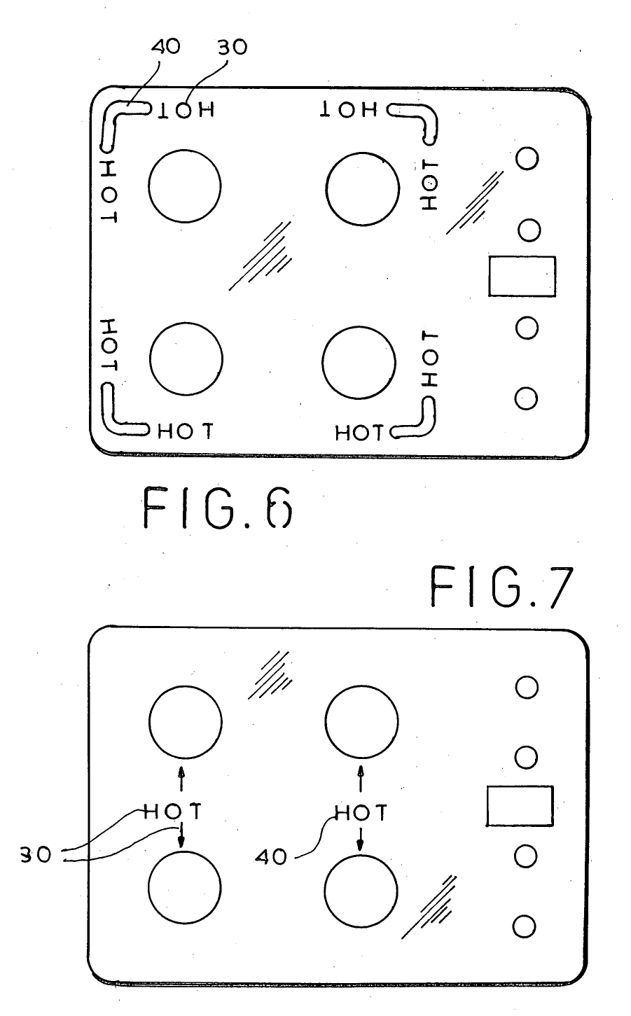

FIG. 6 is a fragmentary plan view of an alternative embodiment of the heat warning safety device of the present invention;

FIG. 7 is a fragmentary plan view of an alternative embodiment of the heat warning safety device of the present invention;

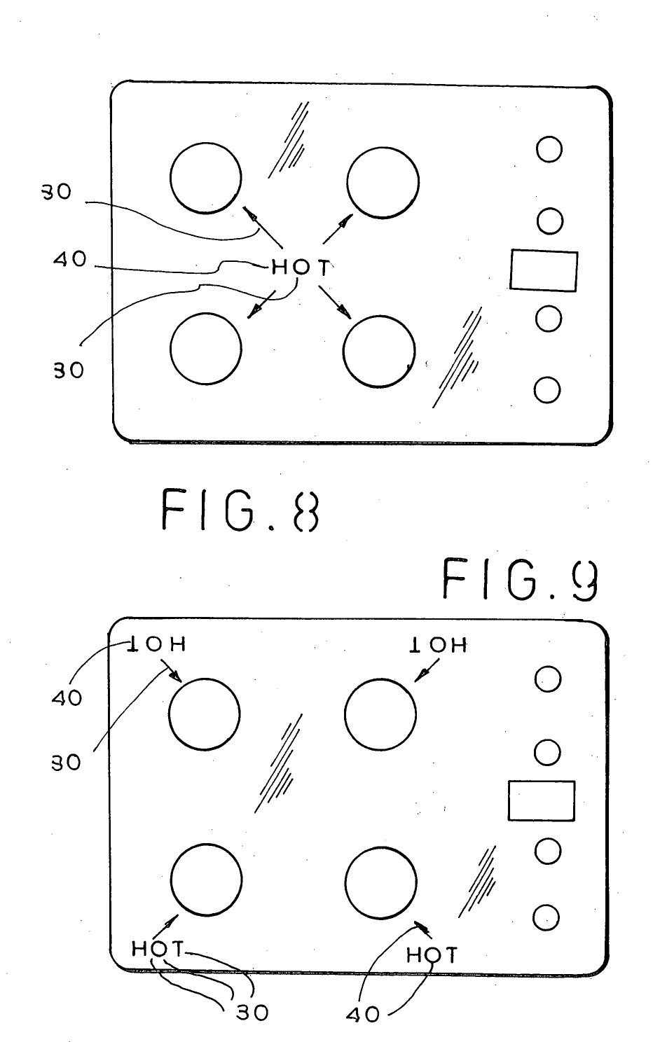

FIG. 8 is a fragmentary plan view of an alternative embodiment of the heat warning safety device of the present invention;

FIG. 9 is a fragmentary plan view of an alternative embodiment of the heat warning safety device of the present invention;

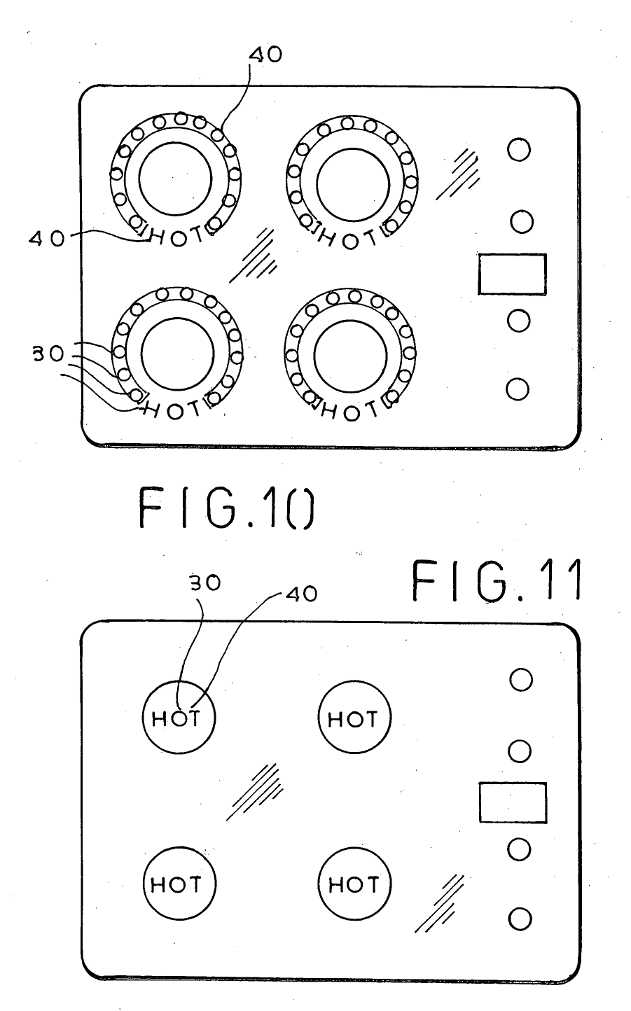

FIG. 10 is a fragmentary plan view of FIG. 1;

FIG. 11 is a fragmentary plan view of an alternative embodiment of the heat warning safety device of the present invention;

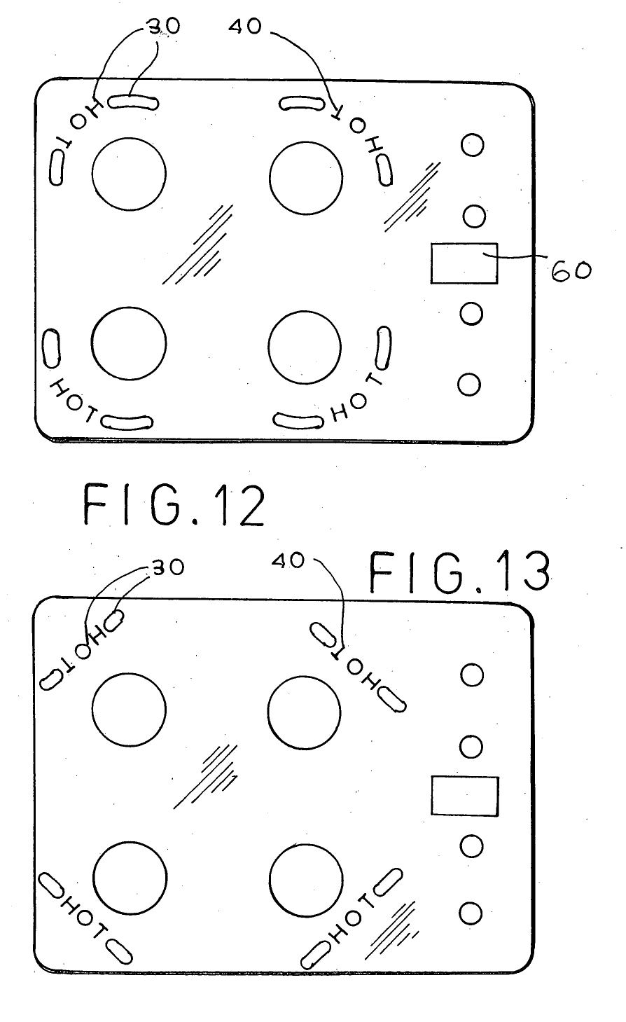

FIG. 12 is a fragmentary plan view of an alternative embodiment of the heat warning safety device of the present invention;

FIG. 13 is a fragmentary plan view of an alternative embodiment of the heat warning safety device of the present invention;

FIG. 14 is a top plan view of the prior art heat warning indicator lights for smooth cooktop stoves;

FIG. 15 is a top plan view of an alternative version of the prior art heat warning indicator lights for smooth cooktop stoves; and

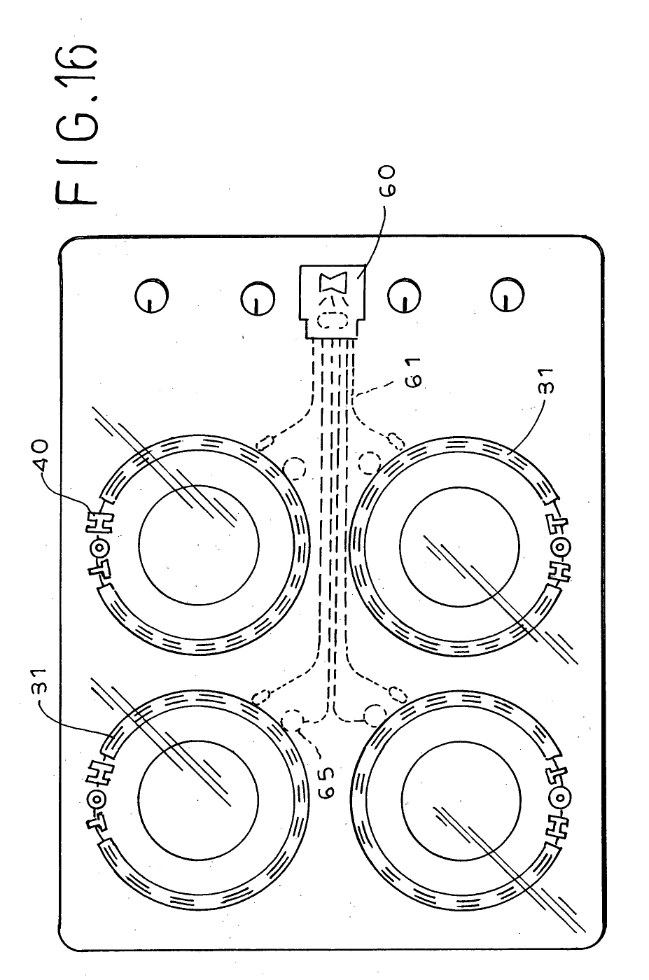

FIG. 16 is a top plan view of the heat warning safety device of the present invention used on a smooth cooktop stove showing a particular configuration of organic light emitting diodes.

### DETAILED DESCRIPTION OF THE PREFERRED EMBODIMENT

The method of the present invention is a method of warning individuals that a surface of a stove containing two or more heating elements may be hot and having a source of electric power embedded in the stove. the method comprises the steps, not necessarily in this order, of (a) installing a controller on a top surface of the stove, (b) installing, for each heating element on the surface, a heat sensor beneath the surface and adjacent the heating element for ascertaining and communicating the temperature of the heating element to the controller, and (c) installing, for each heating element on the surface, a plurality of light emitting diodes adjacent the heating element, the plurality of light emitting diodes in electric communication with the source of electric power (so that the plurality of light emitting diodes can be illuminated) and configured to represent a predetermined heat warning symbol, said symbol alone communicating that the surface is dangerously hot, the symbol readily visible only when illuminated to an observer who can also readily see the surface.

The controller is capable of receiving temperature information from the heat sensors and controlling the light emitting diodes so that whenever a specified surface temperature of a particular heating element is reached, the symbol is illuminated and remains illuminated as long as the specified surface temperature of that heating element is maintained. The plurality of light emitting diodes can also be calibrated so that the symbol illuminates and remains illuminated as long as the surface temperature of the area surrounding or immediately surrounding that heating element is maintained. The heat warning symbols are positioned so that an observer approaching a heating element of the stove when the heating element is dangerously hot can readily see and understand the heat warning symbol of that heating element.

Preferably, when installing the plurality of light emitting diodes configured to represent a heat warning symbol positioned so that an observer approaches a heating element can see the symbol, it is done in a way that the plurality of light emitting diodes are configured to represent a heat warning symbol positioned so that an observer approaching a heating element of the stove from any direction when the heating element is dangerously hot can readily see and understand the heat warning symbol of that heating element.

The method of the present invention can be said to employs an apparatus that is illustrated in the accompanying drawings. That apparatus or device has been assigned reference numeral 10 Other elements of that device have been assigned the reference numerals referred to below. Accordingly, the remainder of the Detailed Description will describe the present invention in terms of that apparatus. But it sould be understood that the present invention is a method that installs the elements of that apparatus in accordance with the above steps.

As seen from FIGS. 1-13, a heat alert safety device for warning individuals that a surface of an object is dangerously hot is presented. FIGS. 14 and 15 describe prior art heat warning indicators. FIG. 1 describes the entire device of the present invention whereas FIGS. 2-13 illustrate the many possible configurations of light emitting diodes that can form the heat warning symbols in various embodiments of the present invention. It is intended that the remaining elements of device 10 shown in FIG. 1 are also incorporated into the embodiments shown in FIGS. 2-9 and 11-13, although these elements are not shown in FIGS. 2-9 and 11-13. So for example, even though electric lines running from the light emitting diodes to the controller are not shown in FIGS. 2-13, and similarly the heat sensors 65 and the communication lines 66 running from the heat sensors 65 to the controller 60 are also not shown in these figures, nonetheless they appear in these embodiments as well.

The most commonly faced object containing a dangerously hot surface, particularly one with residual heat, is a stove. Accordingly, the drawings and below discussion focus on the surface of a stove, such as an electric stove, a gas stove or a smooth cooktop stove. However, other objects containing other surfaces are also contemplated. Furthermore, although the heat alert safety device is illustrated in the drawings in the context of a surface of a stove that contains four heating elements, the device 10 of the present invention is also applicable to a stove having a any number of heating elements or hot surfaces, especially two or more such heating elements or hot surfaces. Moreover, it need not necessarily be the heating element of the stove or other object that is the surface that is being against for heat, although that is typical. Device can be used on other areas of a stove of other object other than the surface containing the heating elements.

The device of the present invention is designed specifically so that each surface or area of a surface that may become dangerously hot (especially at a time when one would ordinarily expect that surface to not be so hot, for example when there is residual heat after the heat source has been turned off) has an associated heat warning symbol that warns of the danger of touching that surface. In the context of stoves with multiple heating elements, that means that each heating element on the surface of the stove has a separate heat warning symbol designed to warn that that particular heating element may be dangerously hot. Furthermore, it is critical to the present invention that the heat warning elements are designed to maximize the chance that observers who might touch the surface will adequately understand and react to the warning symbol and refrain from touching the surface.

For each heating element on the surface being warned against, device 10 includes a heat sensor 65 which is typically beneath the surface and adjacent the heating element for ascertaining and communicating the temperature of the heating element to the controller via communication lines that run beneath the surface from the heat sensor to the controller. Furthermore, specific to each heating element being warned against is a configuration of light emitting diodes 30 . Plurality of light emitting diodes 30 is located adjacent the heating element. In most cases this will mean within inches of the heating element although. Adjacent means close enough that an observer would know that the heat warning symbol formed by the plurality of light emitting diodes is associated with that heating element. The plurality of light emitting diodes is configured to represent a predetermined heat warning symbol. The symbol alone, without reference to the symbols associated with other heating elements, communicates to an observer that the surface is dangerously hot. The symbol is readily visible only when illuminated and it is readily visible to an observer. The relevant observer is who can also readily see the surface that may be too hot.

Typically there are electric lines 61 running beneath the surface of the stove connecting the source of electric power to the plurality of light emitting diodes so that the electric diodes can be illuminated. In the case of the smooth cooktop wherein a halogen lamp is embedded directly below the smooth glass or metal heating element, the electric lines have to be positioned so that they are not subjected to intense heat. Furthermore, all the electric lines have to be positioned in all stoves in a manner that does not subject them to excessive heat or electromagnetic interference. It is well known in the art to accomplish this.

Device 10 includes an electric power source 20 that is embedded within the appliance under the surface. Typically, power source 20 is a standard electric power source.

The heat warning symbol 40 is readily visible when illuminated to an observer who can also readily see the surface. In a preferred embodiment, the heat warning symbol 40 is not visible at all or very much when not illuminated. Thus the illumination communicates information to the observer. When illuminated, the heat warning symbol communicates that the surface is dangerously hot. “Dangerously hot” or “dangerous heat” is a general term that is intended merely to refer to a surface that is “too hot” for some reason. Typically, this refers to a surface that is “too hot to touch” and that temperature has been found to mean a temperature approximately 115 (or in some cases 114 or 113 degrees Fahrenheit). Alternatively, “dangerously hot” could also mean the temperature at which a bum is caused from one second of contact to an adult, which is approximately 167 degrees Fahrenheit. As indicated, however, the term “dangerously hot” or “dangerous heat” in this patent application refers generally to any specified temperature that has been determined to be undesirable due to its heat level. The present invention therefore definitely contemplates that the specified triggering temperature could be other temperatures above or below 115 degrees (or above or below 167 degrees) Fahrenheit.

Examples of heat warning symbols 40 in accordance with the present invention include the letters “HOT” or equivalent letters in a foreign language, or any other immediately recognizable symbol of dangerous heat. Accordingly, when in this patent application, the heat warning symbol of the present invention is described with the phrase “the letters “HOT”, it is intended that this also include embodiments in which the lettering comprising a word that means “HOT” in a foreign language is used instead of the actual English letters “H”, “O” and “T”.

Heat warning symbols 40 associated with each heating element are positioned so that an observer approaching a heating element of the stove from any direction at a time when that heating element is dangerously hot can readily see and understand the heat warning symbol of that heating element. Examples of such heat warning symbols are shown in the drawing FIGS. 1-13. In all the examples, all light emitting diodes of the heat warning symbol go on or off together.

Often, although not necessarily, the heat warning symbol for all the heating elements, or at least for at least one of the heating elements, includes the letters “HOT” as a portion of the symbol. In FIG. 11, for example, the letters “HOT” form the entire heat warning symbol 40 and the symbol 40 appears in a center of the heating element of the stove Alternatively, or in combination with the above symbol, as best seen in FIGS. 2, 3, 4 the heat warning symbol comprises an arrangement of LED's that forms a complete perimeter around the heating element. As seen from FIGS. 2 and 3, the perimeter is usually a circular perimeter although it could also be a square, rectangular or other perimeter, as seen in FIG. 4. In one embodiment shown in FIGS. 1 and 10, the perimeter is interrupted by the letters “HOT”. It should be noted that in this as in all other embodiments, these letters (“H”,“O”,“T”) are themselves also formed of the light emitting diodes. In fact, in order to ensure that all light emitting diodes in the letters and all light emitting diodes in the perimeter all go on and off in concert, well known means in the art of electric circuitry are employed. For example, a series circuit can be set up whereby all the light emitting diodes of a single heat warning symbol are arranged in a series. This includes the LEDs of the lettering and the LEDs of the perimeter other than the lettering.

Furthermore, the embodiments shown in FIGS. 1-4 are best designed for stoves located in island sections of a kitchen in that they are designed to warn the observer regardless of the direction that the observer attempts to touch the heating element from.

In certain embodiments, the heat warning symbol 40 includes an arrangement of LED's that only partially encircles the heating element but to maximize the effectiveness of the warning system the LEDs are positioned between the heating element and the direction from which an observer is most likely to approach the heating element. This is best seen in FIGS. 5, 6, 12, 13. The embodiment shown in FIG. 9 represents a limited partial encirclement of the heating element. In FIGS. 5, 6, 12, 13, (and to a lesser extent FIG. 9) the heat warning symbols 40 are positioned to be between the heating element and the observer sticking his or her hand toward the heating element from the most likely direction an observer would approach from.

In FIGS. 7 and 8, the heat warning symbol 40 is comprised of a combination of the letters “HOT” and an arrow indicating which heating element among two or four heating elements the lettering refers to. In another words, in this embodiment, if the heating element were dangerously hot, the lettering “HOT” would illuminate simultaneously with the arrow that corresponds with the heating element that exceeds the specified temperature. The presence of an arrow would direct the eye of the observer to the heating element that is dangerously hot to increase the effectiveness of the warning.

Device 10 also includes a controller 60 controlling the source 20 of electric power in a manner that whenever a specified surface temperature of the surface being warned against is reached, the heat warning symbol is illuminated and remains illuminated as long as the specified surface temperature is maintained. Controller 60 thus controls the light emitting diodes so that whenever a specified surface temperature of a particular heating element is reached, the symbol is illuminated and remains illuminated as long as the specified temperature of that heating element is maintained. The controller 60 could be or could include a computer chip or any other suitable component or thing including hardware or software that tells the electric power source to go on when a specified temperature is reached. Controller 60 would ideally be located in a preferred embodiment near power source 20 distant from the heating elements or the potentially dangerously hot surface. In one embodiment, controller 60 could be housed in the same compartment or box as a switch controlling the power source 20, a device indicator 80 and sound producing source 24 (described below)

Controller 60 would receive information about the temperature of the heating element in a manner well known in the art from the heat sensors. Presently, heat indicators consisting of a dot of LED poorly positioned on the stove or other surface operate by receiving information about the temperature of the heating element or other surface and then they convert that information into an LED that is illuminated. In the present invention, the basic idea would be similar as to the manner of controlling the light emitting diodes. For example, there could be heat sensors 65 adjacent each heating element that is connected by wire to the controller. Heat sensors 65 ascertains the surface temperature, for example, the temperature of the surface of a heating element, and communicates that temperature to the controller 60 via communication lines 66 shown in dashed lines in FIG. 1.

In a case where the surface that is being warned against is the heating elements of a stove (for example a gas stove, an electric stove, or a smooth cooktop stove) or the area of the top surface of a stove where the heating elements are located, then typically, although not necessarily, the power source would also be located on the top surface of the stove as far removed from the heating elements as possible. In one embodiment, the power source would be near the control knobs of the stove.

Device 10 may also include switch 90 that is accessible to a user. In a preferred embodiment switch 90 is located on the object containing the surface that the heat warning symbol 40 is warning may be dangerously hot. Switch 90 is used to turn the heat warning safety device 10 on or off, for example by tuning the power source 20 itself on or off. Device 10, in certain embodiments, also includes a device indicator 80 that notifies the user whether device 10 is functional and can be relied on. The device would likely only become nonfunctional when and if the LEDs get used up. If device 10 includes switch 90 then in certain embodiments device indicator 80 would go on when switch 90 is turned on provided LEDs are functional. Alternatively, device indicator 80 is not affected by switch 90 but is a permanent indicator that independently changes indication mode whenever one or more of light emitting diodes forming symbol 40 becomes nonfunctional and need to be replaced. Hence, a user knows whether to rely on device 10.

The device 10 of the present invention also allows the brightness of the heat warning symbol 40 to be adjusted depending upon the individuals who are likely to need the warning that the surface may be dangerously hot. Controller 60 would adjust the brightness of light emitting diodes 30 in the same manner that controller turns light emitting diodes 30 “on” using well known means and based on a setting chosen by the user. The setting would appear on switch 90 or with a separate switch. Another feature of the present invention is that a sound producing component 24 can produce a sound warning whenever the light emitting diodes 30 are on. This is not just advantageous to visually impaired individuals. For all individuals, it compounds the effect of the warning. To achieve this objective, one need only have a sound producing device 24 that is connected to the controller 60. Obviously, the nature, length, volume and other characteristics of the sound alarm can also be adjustable and can be controlled by software.

A still further feature of the present invention is that the illumination of the light emitting diodes can be alternating to create a blinking effect that heightens the warning power of the heat warning symbol. This is effectuated wherein in blink mode, a mode activated by the user, controller 60 simply alternately illuminates the light emitting diodes above the specified temperature rather than providing continuous illumination.

The advantage of these additional features is seen from the following example. Consider a single young male who lives alone. He may typically maintain the brightness level of device 10 at a low level at all times. This is because he sees well and is not distracted and also because when he entertains he does not want to unnecessarily visually clutter or detract from the appealing appearance of his smooth cooktop. When he gets married, his wife is protective and turns up the brightness of the device 10 to protect the children who she is fearful may not see a low level warning device 10. When their elderly parents come to visit they turn up the brightness of the device 10 further and put the sound feature on.

It should be noted that the term “plurality of light emitting diodes” is used in this patent application broadly and that this term encompasses more than the ordinary English language definition of such phrase. For example, it is contemplated that rather than a plurality of light emitting diodes being used to illuminate and form the heat warning symbol, a single light emitting diode could in certain instances be used. For example, the single LED could emit light from a line rather than a point. In this case, the term “plurality of light emitting diodes” shall be taken to mean that it includes a single light emitting diode that is strong enough or that is shaped to emit light from an area normally occupied by a plurality of light emitting diodes, i.e. an area wider than a single point. In addition, the term a “plurality of light emitting diodes” shall also include a single light emitting diode whose light is enhanced, such as by a reflecting surface, to emit light from an area larger than a point.

Orgnaic Light Emitting Diodes (OLEDs)

As best seen in FIG. 16, in an alternative embodiment of the present invention, device 10 of the present invention is essentially the same except that the LEDs can be replaced by organic light emitting diodes (“OLEDs”) 31. One or more organic light emitting diodes would be installed (such as by being sprayed, painted, stenciled on like ink) instead of installing a plurality of light emitting diodes. Everything else would be essentially the same. There would still be electric lines running from controller 60 to the OLEDs and there would still be heat sensors 65 and heat sensor communication lines 66 to the controller 60.

Conceptually, OLEDs 31 represent a cross between thermochromic compositions (since they can be sprayed) and ordinary light emitting diodes (since they operate based on an electric current). In the context of the present invention, they would have the good points of both. They can be sprayed on like thermochromic compositions. Yet they would have the good traits of heat warning safety devices that use LEDs to form the heat warning symbol over heat warning safety devices that use thermochromic compositions to form the heat warning symbol. These advantages include durability and effectiveness at very high temperatures, the ability to illuminate and be seen instantly, the ability to be adjusted for brightness and the capacity to be seen in the dark.

Organic light emitting diodes are relatively new but have been used already in simple displays. A company called Philips Research uses an O.L.E.D. display on an electric razor. O.L.E.D.s can be printed on flexible material like plastic. Furthermore, O.L.E.D.s, unlike flat panel displays of thermochromic composition, have a wide viewing angle of up to 160 degrees in arc. Furthermore, O.L.E.D.s maintain their clarity and range of visibility even in bright light. Accordingly, O.L.E.D.s can also be used on stand-alone removable “hot button” type versions of a heat alert safety device of the present invention of the kind described in U.S. patent application Ser. No. 09/788,594 and U.S. patent application Ser. No. 10/238,348 of Applicant Lerner. O.L.E.D. displays also consume a low amount of power and produce very bright images.

In addition, heat warning safety devices of the present invention that employ O.L.E.D.s to form the heat warning symbol are thinner than ordinary LED-based devices and thereofre use less space and are more versatile.

It is to be understood that while the apparatus of this invention have been described and illustrated in detail, the above-described embodiments are simply illustrative of the principles of the invention. It is to be understood also that various other modifications and changes may be devised by those skilled in the art which will embody the principles of the invention and fall within the spirit and scope thereof It is not desired to limit the invention to the exact construction and operation shown and described. The spirit and scope of this invention are limited only by the spirit and scope of the following claims.

What is claimed is:

1. A method of warning individuals that a surface of a stove containing two or more heating elements may be hot, the stove having a source of electric power, comprising:
(a) installing a controller on a top surface of the stove,
(b) installing, for each heating element on the surface, a heat sensor beneath the surface and adjacent the heating element for ascertaining and communicating the temperature of the heating element to the controller,
(c) installing, for each heating element on the surface, a plurality of light emitting diodes adjacent the heating element, the plurality of light emitting diodes in electric communication with the source of electric power so that the plurality of light emitting diodes can be illuminated and configured to represent a predetermined heat warning symbol, said symbol alone communicating that the surface is dangerously hot, the symbol readily visible only when illuminated to an observer who can also readily see the surface,
the controller capable of receiving temperature information from the heat sensors and controlling the light emitting diodes so that whenever a specified surface temperature of a particular heating element is reached, the symbol is illuminated and remains illuminated as long as the specified surface temperature of that heating element is maintained,
the heat warning symbols positioned so that an observer approaching a heating element of the stove when said heating element is dangerously hot can readily see and understand the heat warning symbol of that heating element.

2. The method of claim 1, wherein installing the plurality of light emitting diodes configured to represent a heat warning symbol positioned so that an observer approaching a heating element can see the symbol involves installing the plurality of light emitting diodes configured to represent a heat warning symbol positioned so that an observer approaching a heating element of the stove from any direction when said heating element is dangerously hot can readily see and understand the heat warning symbol of that heating element.

3. The method of claim 1, wherein installing the plurality of light emitting diodes configured to represent a heat warning symbol involves installing the plurality of light emitting diodes configured to represent a heat warning symbol that includes the letters “HOT” as a portion of the symbol

4. The method of claim 1, wherein installing the plurality of light emitting diodes configured to represent a heat warning symbol involves installing the plurality of light emitting diodes configured to represent a heat warning symbol that comprises an arrangement of LED's that forms a perimeter around the heating element.

5. The method of claim 4, wherein installing the plurality of light emitting diodes configured to represent a heat warning symbol involves installing the plurality of light emitting diodes configured to represent a heat warning symbol that comprises an arrangement of LED's that forms a perimeter around the heating element and the perimeter is interrupted by the letters “HOT”.

6. The method of claim 1, wherein installing the plurality of light emitting diodes configured to represent a heat warning symbol includes installing the plurality of light emitting diodes configured to represent a heat warning symbol that includes an arrangement of LED's that partially encircles the heating element and that is positioned between the heating element and an observer approaching the heating element

7. The method of claim 6, wherein installing the plurality of light emitting diodes configured to represent a heat warning symbol includes installing the plurality of light emitting diodes configured to represent a heat warning symbol that includes an arrangement of LED's that partially encircles the heating element and that is positioned between the heating element and an observer approaching the heating element and wherein the symbol includes the letters “HOT”

8. The method of claim 1, wherein the method also includes installing a switch for turning on or off the ability of the plurality of light emitting diodes to receive electric power from the source of electric power.

9. The method of claim 1, wherein the method also includes the step of installing an indicator device that notifies the user whether the plurality of light emitting diodes no longer functions to illuminate and remain illuminated as long as the specified surface temperature of that heating element is maintained.

10. The method of claim 1, wherein installing a controller involves installing a controller that can control a degree of brightness of the plurality of light emitting diodes based on a setting set by a user.

11. The method of claim 1, wherein installing a controller involves installing a controller that can control a sound producing component that produces a sound alarm whenever the plurality of light emitting diodes is turned on.

12. The method of claim 1, wherein the plurality of light emitting diodes can alternate in illumination to create a blinking effect that heightens the warning power of the heat warning symbol.

13. A method of warning individuals that a surface of a stove containing two or more heating elements may be hot, the stove having a source of electric power, comprising:
(a) installing a controller on a top surface of the stove,
(b) installing, for each heating element on the surface, a heat sensor beneath the surface and adjacent the heating element for ascertaining and communicating the temperature of the heating element to the controller,
(c) installing, for each heating element on the surface, a plurality of light emitting diodes adjacent the heating element, the plurality of light emitting diodes in electric communication with the source of electric power so that the plurality of light emitting diodes can be illuminated and configured to represent a predetermined heat warning symbol, said symbol alone communicating that the surface is dangerously hot, the symbol readily visible only when illuminated to an observer who can also readily see the surface,
the controller capable of receiving temperature information from the heat sensors and controlling the light emitting diodes so that whenever a specified surface temperature of an area surrounding a particular heating element is reached, the symbol is illuminated and remains illuminated as long as the specified surface temperature of that heating element is maintained,
the heat warning symbols positioned so that an observer approaching a heating element of the stove when said heating element is dangerously hot can readily see and understand the heat warning symbol of that heating element.

14. The method of claim 13, wherein installing the plurality of light emitting diodes configured to represent a heat warning symbol positioned so that an observer approaching a heating element can see the symbol involves installing the plurality of light emitting diodes configured to represent a heat warning symbol positioned so that an observer approaching a heating element of the stove from any direction when said heating element is dangerously hot can readily see and understand the heat warning symbol of that heating element.

15. The method of claim 13, wherein installing the plurality of light emitting diodes configured to represent a heat warning symbol involves installing the plurality of light emitting diodes configured to represent a heat warning symbol that includes the letters “HOT” as a portion of the symbol

16. The method of claim 13, wherein installing the plurality of light emitting diodes configured to represent a heat warning symbol involves installing the plurality of light emitting diodes configured to represent a heat warning symbol that comprises an arrangement of LED's that forms a perimeter around the heating element.

17. The method of claim 16, wherein installing the plurality of light emitting diodes configured to represent a heat warning symbol involves installing the plurality of light emitting diodes configured to represent a heat warning symbol that comprises an arrangement of LED's that forms a perimeter around the heating element and the perimeter is interrupted by the letters “HOT”.

18. The method of claim 13, wherein installing the plurality of light emitting diodes configured to represent a heat warning symbol includes installing the plurality of light emitting diodes configured to represent a heat warning symbol that includes an arrangement of LED's that partially encircles the heating element and that is positioned between the heating element and an observer approaching the heating element

19. The method of claim 18, wherein installing the plurality of light emitting diodes configured to represent a heat warning symbol includes installing the plurality of light emitting diodes configured to represent a heat warning symbol that includes an arrangement of LED's that partially encircles the heating element and that is positioned between the heating element and an observer approaching the heating element and wherein the symbol includes the letters “HOT”

20. The method of claim 13, wherein the method also includes installing a switch for turning on or off the ability of the plurality of light emitting diodes to receive electric power from the source of electric power.

21. The method of claim 13, wherein the method also includes the step of installing an indicator device that notifies the user whether the plurality of light emitting diodes no longer functions to illuminate and remain illuminated as long as the specified surface temperature of that heating element is maintained.

22. The method of claim 13, wherein installing a controller involves installing a controller that can control a degree of brightness of the plurality of light emitting diodes based on a setting set by a user.

23. The method of claim 13, wherein installing a controller involves installing a controller that can control a sound producing component that produces a sound alarm whenever the plurality of light emitting diodes is turned on.

24. The method of claim 13, wherein the plurality of light emitting diodes can alternate in illumination to create a blinking effect that heightens the warning power of the heat warning symbol.

25. A method of warning individuals that a surface of a stove containing two or more heating elements may be hot, the stove having a source of electric power, comprising:
(a) installing a controller on a top surface of the stove,
(b) installing, for each heating element on the surface, a heat sensor beneath the surface and adjacent the heating element for ascertaining and communicating the temperature of the heating element to the controller,
(c) installing, for each heating element on the surface, one or more organic light emitting diodes adjacent the heating element, the one or more organic light emitting diodes in electric communication with the source of electric power so that the one or more organic light emitting diodes can be illuminated and configured to represent a predetermined heat warning symbol, said symbol alone communicating that the surface is dangerously hot, the symbol readily visible only when illuminated to an observer who can also readily see the surface,
the controller capable of receiving temperature information from the heat sensors and controlling the one or more light emitting diodes so that whenever a specified surface temperature of a particular heating element is reached, the symbol is illuminated and remains illuminated as long as the specified surface temperature of that heating element is maintained,
the heat warning symbols positioned so that an observer approaching a heating element of the stove when said heating element is dangerously hot can readily see and understand the heat warning symbol of that heating element.

26. The method of claim 25, wherein installing the one or more organic light emitting diodes configured to represent a heat warning symbol positioned so that an observer approaching a heating element can see the symbol involves installing the one or more organic light emitting diodes configured to represent a heat warning symbol positioned so that an observer approaching a heating element of the stove from any direction when said heating element is dangerously hot can readily see and understand the heat warning symbol of that heating element.

27. The method of claim 25, wherein installing the one or more organic light emitting diodes configured to represent a heat warning symbol involves installing the one or more organic light emitting diodes configured to represent a heat warning symbol that includes the letters “HOT” as a portion of the symbol

28. The method of claim 25, wherein installing the one or more organic light emitting diodes configured to represent a heat warning symbol involves installing the one or more organic light emitting diodes configured to represent a heat warning symbol that comprises an arrangement of LED's that forms a perimeter around the heating element.

29. The method of claim 28, wherein installing the one or more organic light emitting diodes configured to represent a heat warning symbol involves installing the one or more organic light emitting diodes configured to represent a heat warning symbol that comprises an arrangement of LED's that forms a perimeter around the heating element and the perimeter is interrupted by the letters “HOT”.

30. The method of claim 25, wherein installing the one or more organic light emitting diodes configured to represent a heat warning symbol includes installing the one or more organic light emitting diodes configured to represent a heat warning symbol that includes an arrangement of LED's that partially encircles the heating element and that is positioned between the heating element and an observer approaching the heating element

31. The method of claim 30, wherein installing the one or more organic light emitting diodes configured to represent a heat warning symbol includes installing the one or more organic light emitting diodes configured to represent a heat warning symbol that includes an arrangement of LED's that partially encircles the heating element and that is positioned between the heating element and an observer approaching the heating element and wherein the symbol includes the letters “HOT”

32. The method of claim 25, wherein the method also includes installing a switch for turning on or off the ability of the one or more organic light emitting diodes to receive electric power from the source of electric power.

33. The method of claim 25, wherein the method also includes the step of installing an indicator device that notifies the user whether the one or more organic light emitting diodes no longer functions to illuminate and remain illuminated as long as the specified surface temperature of that heating element is maintained.

34. The method of claim 25, wherein installing a controller involves installing a controller that can control a degree of brightness of the one or more organic light emitting diodes based on a setting set by a user.

35. The method of claim 25, wherein installing a controller involves installing a controller that can control a sound producing component that produces a sound alarm whenever the one or more organic light emitting diodes is turned on.

36. The method of claim 25, wherein the one or more organic light emitting diodes can alternate in illumination to create a blinking effect that heightens the warning power of the heat warning symbol.

37. A method of warning individuals that a surface of a stove containing two or more heating elements may be hot, the stove having a source of electric power, comprising:
(a) installing a controller on a top surface of the stove,
(b) installing, for each heating element on the surface, a heat sensor beneath the surface and adjacent the heating element for ascertaining and communicating the temperature of the heating element to the controller,
(c) installing, for each heating element on the surface, one or more organic light emitting diodes adjacent the heating element, the one or more organic light emitting diodes in electric communication with the source of electric power so that the one or more organic light emitting diodes can be illuminated and configured to represent a predetermined heat warning symbol, said symbol alone communicating that the surface is dangerously hot, the symbol readily visible only when illuminated to an observer who can also readily see the surface,
the controller capable of receiving temperature information from the heat sensors and controlling the one or more light emitting diodes so that whenever a specified surface temperature of an area surrounding a particular heating element is reached, the symbol is illuminated and remains illuminated as long as the specified surface temperature of that heating element is maintained,
the heat warning symbols positioned so that an observer approaching a heating element of the stove when said heating element is dangerously hot can readily see and understand the heat warning symbol of that heating element.

38. The method of claim 37, wherein installing the one or more organic light emitting diodes configured to represent a heat warning symbol positioned so that an observer approaching a heating element can see the symbol involves installing the one or more organic light emitting diodes configured to represent a heat warning symbol positioned so that an observer approaching a heating element of the stove from any direction when said heating element is dangerously hot can readily see and understand the heat warning symbol of that heating element.

39. The method of claim 37, wherein installing the one or more organic light emitting diodes configured to represent a heat warning symbol involves installing the one or more organic light emitting diodes configured to represent a heat warning symbol that includes the letters “HOT” as a portion of the symbol

40. The method of claim 37, wherein installing the one or more organic light emitting diodes configured to represent a heat warning symbol involves installing the one or more organic light emitting diodes configured to represent a heat warning symbol that comprises an arrangement of LED's that forms a perimeter around the heating element.

41. The method of claim 40, wherein installing the one or more organic light emitting diodes configured to represent a heat warning symbol involves installing the one or more organic light emitting diodes configured to represent a heat warning symbol that comprises an arrangement of LED's that forms a perimeter around the heating element and the perimeter is interrupted by the letters “HOT”.

42. The method of claim 37, wherein installing the one or more organic light emitting diodes configured to represent a heat warning symbol includes installing the one or more organic light emitting diodes configured to represent a heat warning symbol that includes an arrangement of LED's that partially encircles the heating element and that is positioned between the heating element and an observer approaching the heating element

43. The method of claim 42, wherein installing the one or more organic light emitting diodes configured to represent a heat warning symbol includes installing the one or more organic light emitting diodes configured to represent a heat warning symbol that includes an arrangement of LED's that partially encircles the heating element and that is positioned between the heating element and an observer approaching the heating element and wherein the symbol includes the letters “HOT”

44. The method of claim 37, wherein the method also includes installing a switch for turning on or off the ability of the one or more organic light emitting diodes to receive electric power from the source of electric power.

45. The method of claim 37, wherein the method also includes the step of installing an indicator device that notifies the user whether the one or more organic light emitting diodes no longer functions to illuminate and remain illuminated as long as the specified surface temperature of that heating element is maintained.

46. The method of claim 37, wherein installing a controller involves installing a controller that can control a degree of brightness of the one or more organic light emitting diodes based on a setting set by a user.

47. The method of claim 37, wherein installing a controller involves installing a controller that can control a sound producing component that produces a sound alarm whenever the one or more organic light emitting diodes is turned on.

48. The method of claim 37, wherein the one or more organic light emitting diodes can alternate in illumination to create a blinking effect that heightens the warning power of the heat warning symbol.
